(19) United States
(12) Patent Application Publication
(10) Pub. No.: US 2013/0340342 A1
(43) Pub. Date: Dec. 26, 2013

(54) APPARATUS FOR MOVING A FURNITURE PART WHICH IS HELD IN A MOVABLE MANNER, AND FURNITURE

(71) Applicant: Grass GmbH, (US)

(72) Inventor: Jürgen AHLFELD, Weissensberg (DE)

(73) Assignee: Grass GmbH, Hochst (AT)

(21) Appl. No.: 13/872,189

(22) Filed: Apr. 29, 2013

Related U.S. Application Data
(63) Continuation of application No. PCT/EP2011/005357, filed on Oct. 25, 2011.

(30) Foreign Application Priority Data
Oct. 28, 2010 (DE) 20 2010 014 732.8

(51) Int. Cl. E05F 15/20

(52) U.S. Cl. CPC E05F 15/20
USPC 49/31; 318/3

(57) ABSTRACT

An apparatus for moving a furniture part in a movable manner on a furniture body, having a drive unit, a control unit, and a sensor device which interacts with the control unit, wherein the movable furniture part can be moved in an opening direction and a closing direction in a driven manner relative to the furniture body. The drive unit is coupled to the movable furniture part and drives the movable furniture part in a drive mode of the drive unit. The control unit and the sensor device are designed such that, when the apparatus is in the assembled use state, the sensor device identifies an action by an operator on the movable furniture part from the outside as an action with the purpose of moving the furniture part in a manner which can be predefined by the operator and provides a corresponding sensor signal to the control unit.

### CROSS-REFERENCE TO RELATED APPLICATIONS

This application is a continuation of International Application No. PCT/EP2011/005357, filed Oct. 25, 2011, and claims the benefit under 35 USC §119(a)-(d) of German Application No. 20 2010 014 732.8 filed Oct. 28, 2010.

### BACKGROUND OF THE INVENTION

Furniture and apparatuses for moving furniture parts using a drive unit for moving a furniture part which is held on a furniture body in a movable manner are known. A superordinate control unit, for example a closed-loop control unit, can interact with the drive unit in order to control the movement of the movable furniture part. The control unit can additionally communicate with a sensor apparatus for detecting variables which are required for controlling the movement of the movable furniture part. Corresponding interfaces can be present for the purpose of transmitting a drive effect from the drive unit to the movable furniture part.

### SUMMARY OF THE INVENTION

One object of the present invention is to design an apparatus or an item of furniture of the type mentioned in the introductory part such that it is advantageous for different operator control situations. In particular, it should advantageously be possible to move the movable furniture part using different movement patterns.

The invention proceeds from an apparatus for moving a furniture part which is held in a movable manner on a furniture body, having a drive unit and a control unit and also a sensor device which interacts with the control unit, wherein the movable furniture part can be moved in an opening direction and/or a closing direction in a driven manner relative to the furniture body, wherein the drive unit is coupled to the movable furniture part and drives the movable furniture part in a drive mode of the drive unit. The coupling can be, for example, a geared coupling and/or a coupling which can be established and released in some other way, or a fixed coupling. The control unit serves, in particular, to operate the drive unit. The sensor device provides, in particular, sensor signals which can be processed by the control unit.

The furniture part which is held in a movable manner can be, for example, a drawer which is held in a movable manner on a furniture body such that it can be displaced by means of a guide unit, or a pull-out means or a door, hatch or the like which can be pivoted in relation to a furniture body.

In general, an interface with, for example, gear or coupling components is provided between an output side of the drive unit and a drive side which is associated with the movable furniture part, it being possible for the interface to be acted on by means of the drive unit or the control unit in order to realize different interface situations.

The essence of the invention is that the control unit and the sensor device are designed such that, when the apparatus is in the assembled use state, the sensor device identifies an action by an operator on the movable furniture part from the outside as an action with the purpose of moving the furniture part in a manner which can be predefined by the operator, and provides a corresponding sensor signal to the control unit, wherein the drive unit is in the drive mode and neither counters the force which is applied on the movable furniture part by the operator nor assists said force. In this case, a state is considered, in particular, in which the force which is applied by the operator from the outside leads to it being possible for manual movement or opening or closing of the movable furniture part to take place as a result. In this case, at least one force component acts in a direction in which movement travel is possible or which corresponds to a possible movement direction of the movable furniture part relative to the body. Although the manually caused movement could also be made possible, as an alternative, by the drive unit in this case, this is the starting point of the invention, according to which the manually caused movement acts with priority and alone, even though there is no passivation of the drive unit. The drive unit and the interface remain in a state which corresponds, in principle, to the driving or active state with the movable furniture part being driven solely by the drive unit. However, a state such that an effect, which begins with the drive unit, on the movement of the movable furniture part is suppressed is set up by means of the control unit. The drive unit therefore runs at the same time and an operative connection between the output side and drive side is likewise maintained, without a movement component being transmitted to the manually moving furniture part by the drive unit by means of this operative chain. In this case, it is therefore advantageously necessary that there is no uncoupling or decoupling or interruption between the output side of the drive unit and the drive side which is associated with the movable furniture part. Structural and/or control-related advantages, for example, can be achieved as a result.

The sensor device, for example a touch-sensitive measuring device, advantageously identifies an action by a hand or in some other way on an operator control side of the movable furniture part, for example by the operator grasping a handle section of the furniture part. The corresponding signals are forwarded to the control unit immediately or with a minimum time delay, for example, in the region of a fraction of a second, and immediately processed in said control unit. Signals are interchanged continuously or at extremely short time intervals, with the result that the respectively currently valid signal from the sensor device, which signal is accordingly correlated to the possibly likewise changing action by the person, is constantly available to the control unit. As a function of this, the control unit can, in turn, control the drive unit such that the desired non-action of the drive unit on the movement of the furniture part is always or permanently maintained. For this purpose, the drive unit can be controlled, for example, in respect of its rotation speed or its torque.

The operator can therefore act on the movable furniture part in virtually any desired manner, for example in an unchanging manner or a dynamically changing manner or suddenly with or without a brief severe change in the direction of action and/or magnitude of the action force, for example, up to complete reversal of the direction of the action force, with the result that the movable furniture part is moved out or moved in relative to the furniture body with a rapid change, with the non-action of the drive unit continuing. To this end, the drive unit and the control unit together with further components have to be correspondingly designed, for example the control unit has to be equipped with a correspondingly powerful processor.

In principle, it is not possible to preclude a brief or low torque being transmitted from the output side to the drive side by the drive unit, despite manual movement of the furniture part, but this torque is so low or brief that it serves only, for example, to overcome run-up resistances during the movement of the furniture part from a stationary state or to overcome briefly and/or unusually acting adhesion forces, for example, at bearing points for mounting the movable furniture part in a movable manner. However, a transmitted torque of this kind alone would not be sufficient to move the movable furniture part to a noticeable extent, that is to say if the parallel acting manual action force by the operator were not in effect.

Overall, an operator is given the impression that the movable furniture part is moved solely as a result of the manual action, that is to say as if there were no possibility of driving by means of the drive unit.

The drive unit is advantageously independent of whether the movable furniture part is opened or closed by the operator or whether the drive unit opens or closes the movable furniture part in a driven manner, in both cases in a state in which it is coupled to the movable furniture part. This allows a comparatively more simple design of the coupling point or interface between the drive unit and the movable furniture part in relation to arrangements which can be selectively uncoupled and coupled.

This results, overall, in an increase in operator- and user-friendliness and at the same time a simplified drive train situation.

The advantages of moving the movable furniture part in a directly driven manner at any time by means of the drive unit are retained without being affected by the arrangement according to the invention. In particular, it is possible to change over from manual movement to drive movement by means of the drive unit, and vice versa, in a rapid and careful manner.

In the event of the movable furniture part being moved manually, the invention allows, in particular, a situation according to which the drive unit, despite the “virtual” drive mode thereof, does not have any effect on the movement of the movable furniture part which goes beyond the movement of the furniture part caused by the operator. Manual operator control of the furniture part is not assisted as a result either.

The invention further proposes that the control unit is designed such that there is no relevant positive or negative acceleration of the movable furniture part due to a drive effect by the drive unit during a movement of the movable furniture part, which movement is determined by action from the outside, despite the coupling between the drive unit and the movable furniture part. Therefore, the operator does not at any time notice movement by the drive unit at the same time. The drive unit therefore does not either accelerate or brake the movable furniture part in relation to the manually predefined movement of the furniture part.

Moreover, it is advantageous for the sensor device to be designed to identify the action by an operator on the movable furniture part from the outside in respect of a resulting predefined movement direction and/or speed of the furniture part due to said action, and to provide a corresponding sensor signal to the control unit. The drive unit can therefore now, in a manner influenced by means of the control unit which processes the sensor signals and correspondingly actuates the drive unit, be moved to a state according to which the driven coupling between the drive unit and the movable furniture part can specifically set up a situation in which the operator cannot establish any effect by the drive unit when the movable furniture part is moved further by manual action.

It is also advantageous for the sensor device to be designed to detect a force and/or a direction of force on the movable furniture part, said force or direction of force being attributable to the action on the movable furniture part from the outside. Therefore, the sensor device can also advantageously be formed by force-measuring devices which are available as standard, for example with strain gauges. As a result, it may additionally be possible to draw an exact distinction between whether the action on the movable furniture part is attributable to a random or unintentional action from the outside or whether the action is conscious or intentional with the purpose of moving the movable furniture part manually.

In an advantageous modification to the subject matter of the invention, the sensor device is designed to continuously identify an action on the furniture part from the outside and/or to deliver sensor signals to the drive unit during operation over predefinable operating phases. Therefore, the above-described operating mode according to the invention can be set up permanently or only temporarily if desired. As an alternative, the sensor device can be deactivated for another operating phase or another effective operating mode can be set up.

The drive unit preferably comprises an electric drive, in particular an electric motor. This is particularly advantageous in respect of motors with a wide variety of designs, dimensions and/or power stages, which motors are available as standard.

One advantageous embodiment of the invention is distinguished in that the electric drive is designed with an electric freewheel with which transmission of a drive effect to the movable furniture part is suppressed when energy is supplied to the drive unit, despite the drive unit being coupled to the movable furniture part. Therefore, despite power being supplied to the drive unit or the drive unit running at the same time, for example with a rotary movement of an output shaft of the drive unit, no movement effect by the drive unit on the movable furniture part can be assumed.

Furthermore, selection means are advantageously present, it being possible to operate the control unit selectively in one operating mode of several different operating modes using said selection means. Therefore, selectively predefined operating modes which are stored, for example, in a memory unit of the control unit are selected or a changeover can be made from an existing operating mode to another operating mode.

The invention also relates to an item of furniture having a furniture body and a furniture part which is held on said furniture body in a movable manner, wherein one of the abovementioned apparatuses is present. Therefore, the advantages described above can be realized in an item of furniture, in particular in an item of furniture having a furniture body together with drawers which are held in a movable manner on the furniture body by means of guide units or rail guides.

The movable furniture part is, in particular, a pivotable furniture hatch, furniture door or the like. The, for example, furniture hatch can be held on the furniture body, in particular, by means of a hinge unit, wherein movement of the furniture hatch is possible by manual action on the furniture hatch or solely by the drive unit.

### DETAILED DESCRIPTION OF THE INVENTION

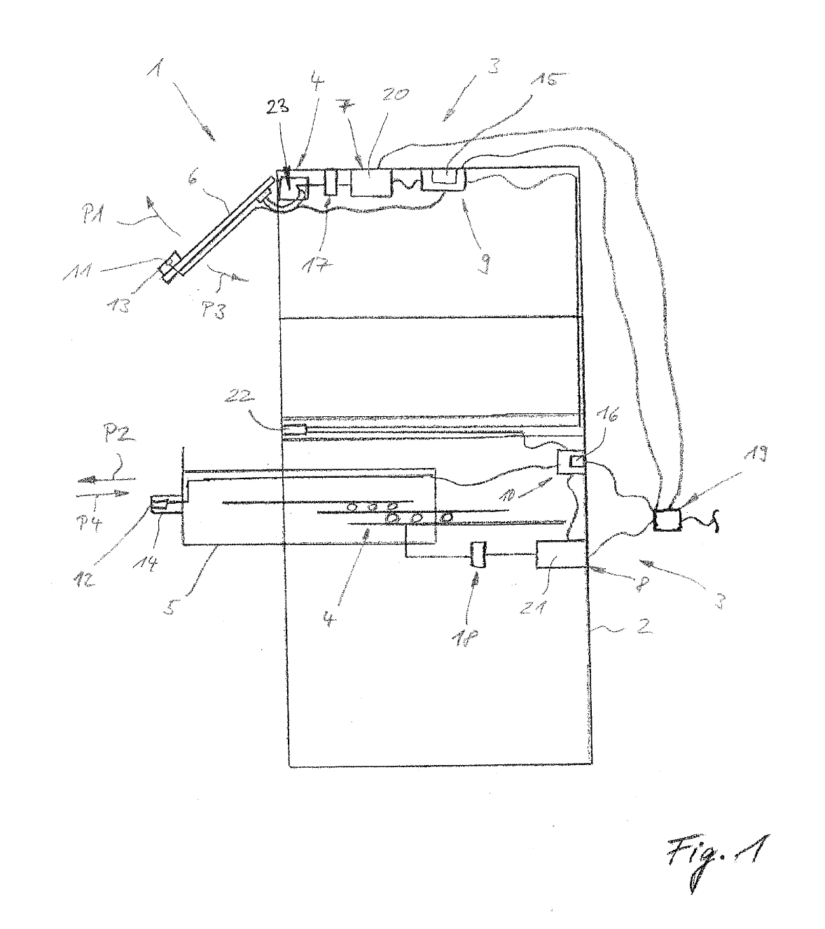

FIG. 1 shows an item of furniture 1 having a furniture body 2 and a furniture part which is held on said furniture body in a movable manner, having an apparatus 3 for moving the furniture part, for example a drawer 5 which is held in a movable manner on the furniture body 2 such that it can be displaced by means of a guide unit 4 and a hatch or furniture hatch 6 which can be pivoted in relation to the furniture body 2 by means of a hinge unit 23. The apparatus 3 comprises a drive unit 7, 8 and a control unit 9, 10, and also a sensor device 11, 12 which interacts with the control unit 9, 10, wherein the movable furniture part can be moved in an opening direction P1, P2 and/or a closing direction P3, P4 in a manner driven relative to the furniture body 2, wherein the drive unit 7, 8 is coupled to the movable furniture part and drives the movable furniture part in a drive mode of the drive unit 7, 8.

The control unit 9, 10 is equipped, for example, with a correspondingly powerful processor 15, 16. Furthermore, selection means 22 are present, it being possible to operate the control unit 9, 10 selectively in one of several different operating modes using said selection means.

An action on an operator control side of the movable furniture part, for example by the operator grasping a handle section 13, 14 of the furniture part, is identified by means of the sensor device 11, 12, for example by way of a touch-sensitive measuring device.

A construction with a coupling point or interface, for example a geared coupling 17, 18, between the drive unit 7, 8 and the movable furniture part is present for the purpose of driven coupling between the drive unit 7, 8 and the movable furniture part.

The drive unit 7, 8 comprises an electric drive or an electric motor 20, 21 and is connected to a power supply 19.

### REFERENCE SYBMOLS

1 Furniture
2 Furniture body
3 Apparatus
4 Guide unit
5 Drawer
6 Furniture hatch
7 Drive unit
8 Drive unit
9 Control unit
10 Control unit
11 Sensor device
12 Sensor device
13 Handle section
14 Handle section
15 Processor
16 Processor
17 Geared coupling
18 Geared coupling
19 Power supply
20 Electric motor
21 Electric motor
22 Selection means
23 Hinge unit

1. An apparatus for moving a furniture part which is held in a movable manner on a furniture body, having a drive unit and a control unit and also a sensor device which interacts with the control unit, wherein the movable furniture part can be moved in an opening direction and a closing direction in a driven manner relative to the furniture body, wherein the drive unit is coupled to the movable furniture part and drives the movable furniture part in a drive mode of the drive unit, wherein the control unit and the sensor device are designed such that, when the apparatus is in the assembled use state, the sensor device identifies an action by an operator on the movable furniture part from the outside as an action with the purpose of moving the furniture part in a manner which can be predefined by the operator and provides a corresponding sensor signal to the control unit, wherein the drive unit is in the drive mode and neither counters the force which is applied on the movable furniture part by the operator nor assists said force,

2. The apparatus as claimed in claim 1, wherein the control unit is designed such that there is no relevant positive or negative acceleration of the movable furniture part due to a drive effect by the drive unit during a movement of the movable furniture part, which movement is determined by action from the outside, despite the coupling between the drive unit and the movable furniture part.

3. The apparatus as claimed in claim 1, wherein the sensor device is designed to identify the action by an operator on the movable furniture part from the outside in respect of a resulting predefined movement direction and/or speed of the furniture part due to said action, and to provide a corresponding sensor signal to the control unit.

4. The apparatus as claimed in claim 1, characterized in thatwherein the sensor device is designed to detect a force and/or a direction of force on the movable furniture part, said force or direction of force being attributable to the action on the movable furniture part from the outside.

5. The apparatus as claimed in claim 1, wherein the sensor device is designed to continuously identify an action on the furniture part from the outside and/or to deliver sensor signals to the drive unit during operation over predefinable operating phases.

6. The apparatus as claimed in one claim 1, wherein the drive unit comprises an electric drive, in particular an electric motor.

7. The apparatus as claimed in claim 6, wherein the electric drive is designed with an electric freewheel with which transmission of a drive effect to the movable furniture part is suppressed when energy is supplied to the drive unit, despite the drive unit being coupled to the movable furniture part.

8. The apparatus as claimed in claim 1, wherein selection means are present, it being possible to operate the control unit selectively in one of several different operating modes using said selection means.

9. An item of furniture having a furniture body and a furniture part which is held on said furniture body in a movable manner, and the furniture includes the apparatus of claim 1.

10. The item of furniture as claimed in claim 9, wherein the movable furniture part s a furniture hatch.
